(19) United States
(12) Patent Application Publication
(10) Pub. No.: US 2003/0035173 A1
(43) Pub. Date: Feb. 20, 2003

(54) Interconnecting processing units of a stored program controlled system using time division muliplexed free space optics

(76) Inventors: Charles Calvin Byers, Aurora, IL (US); Daniel Raymond Hatcher, Clinton, NJ (US)

Correspondence Address: Docket Administrator (Room 3J-219), Lucent Technologies Inc., 101 Crawfords Corner Road, Holmdel, NJ, 07733-3030, US

(21) Appl. No.: 09/932,704

(22) Filed: Aug. 17, 2001

(51) Int. Cl. H04J 14/08; H04B 10/00

(52) U.S. Cl. 359/135; 359/158

(57) ABSTRACT

Internal communication signals in a stored program controlled system comprising a plurality of units configured to process signals are provided by an optical beam line which is proximal to all of the plurality of units. The system of this invention uses Time Division Multiplexing techniques to provide a plurality of logically independent subchannels over a single shared free space optical beam line. The single logical beam is divided temporally among the subchannels, with each subchannel operating for a selected timeslot or timeslots.

### CROSS-REFERENCE TO RELATED APPLICATION

This application is related to U.S. patent application Attorney Docket No. C. C. Byers 39-1, entitled “Interconnecting Processing units of a Stored Program Controlled System Using Free Space Optics”, filed concurrently herewith and commonly assigned to Lucent Technologies Inc., and incorporated by reference herein, with priority claimed for all commonly disclosed subject matter.

This application is also related to U.S. patent application Attorney Docket No. C. C. Byers 42-4, entitled “Interconnecting Processing Units Of A Stored Program Controlled System Using Wavelength Division Multiplexed Free Space Optics”, filed concurrently herewith and commonly assigned to Lucent Technologies Inc., and incorporated by reference herein, with priority claimed for all commonly disclosed subject matter.

This application is also related to U.S. patent application Attorney Docket No. C. C. Byers 43-5, entitled “Interconnecting Processing Units Of A Stored Program Controlled System Using Space Division Multiplexed Free Space Optics”, filed concurrently herewith and commonly assigned to Lucent Technologies Inc., and incorporated by reference herein, with priority claimed for all commonly disclosed subject matter.

This application is also related to U.S. patent application Attorney Docket No. C. C. Byers 44-6, entitled “Installation Of Processing Units Into A Stored Program Controlled System Wherein The Component Processing Units Are Interconnected Via Free Space Optics”, filed concurrently herewith and commonly assigned to Lucent Technologies Inc., and incorporated by reference herein, with priority claimed for all commonly disclosed subject matter.

### Field of the Invention

This invention relates to the field of stored program controlled systems, including, but not limited to, telephone switching offices, data routers, and robotic machine tools; and, more specifically, this invention describes an optical communication path interconnect to provide communications for component processing units of the stored program controlled systems, wherein data is carried on the optical communication path using time division multiplexing.

### BACKGROUND OF THE INVENTION

The invention of U.S. patent application Attorney Docket No. Byers 39-1 discloses a system and method for interconnecting processing units of a stored program controlled system using free space optics. According to this disclosure, an optical beam line carries signals among the various processing units. Multiple distinct streams of data are communicated within that system. When multiple distinct communication streams within a system or network share the same physical media, a multiplexing and Media Access Control (MAC) protocol is necessary for optimal system operation. These protocols help insure that the system performs at the desired capacity, performance and reliability levels.

One important function of any multiplexing and MAC protocol is to divide the limited capacity of the shared physical communication channel among the various logical streams or subchannels that share it. This subdivision of the shared physical channel provides capacity guarantees, so that each of the logical channels receives an equal portion of the available capacity, or a pre-arranged larger or smaller proportion of this capacity. Preallocation of capacity provides a guaranteed level of capacity to all users. Such preallocation is often wasteful of system capacity because, if a given subchannel has no traffic to send, its allocation is idle and unavailable to other connections that may be overloaded.

Other multiplexing and MAC protocols provide statistical multiplexing of the system's capacity, wherein all potential transmitters on the shared channel negotiate for an opportunity to transmit. The theoretical maximum load offered, if all transmitters are operating at full rate, often exceeded the capacity of the shared media, which requires various buffering, queuing and priority techniques to govern when each transmitter operates. This system has potential channel utilization efficiency advantages, at the expense of making it more difficult to guarantee a minimum individual subchannel capacity or latency.

Another important function of the multiplexing and MAC protocols is to direct or route a given channel's traffic to the intended receiver over the shared medium. Channels are often statically mapped using timeslots (or similar separators as known in the art), and the receiver is determined by the timeslot assigned to the transmitter.

In other cases, traffic is offered to the shared medium as packets. These packets contain a destination address, which is used by switching or routing functions to complete the connections.

The concept of priority is also important to multiplexing and MAC protocols. Some messages have a higher priority than others, based upon the importance or time sensitivity of their contents. The multiplexing and MAC protocol must take this priority into account as it manages access to the shared medium.

Security is often an intrinsic function of multiplexing and MAC protocols. If there is a hazard associated with un-authorized interception of a message over the shared medium, the protocol can take steps to eliminate (or at least greatly reduce the impact of) this hazard. One means for heightened security is to physically separate sensitive traffic from all other traffic in the various parallel sub-media in the transmission medium. A more common approach is to use some form of encryption at the transmitter, and decryption at only the authorized receiver(s).

A further function that multiplexing and MAC protocols provide is fault tolerance and fault recovery. If a failure occurs that disables the shared media or significantly reduces its capacity, the protocol invokes various diagnostic actions to discover the source of the problem and the appropriate recovery actions to attempt to correct the source of the problem. Often, the fault recovery operation involves switching the traffic to a redundant medium or attempting to shed load so only the highest priority traffic is allowed on the remaining capacity.

One form of multiplexing and MAC protocols is time division multiplexing. In a Time Division Multiplexed (TDM) system, the shared medium is divided temporally into a series of sequentially occurring timeslots. All subchannels sharing the medium are assigned specific timeslots on which they are allowed to carry their traffic. This timeslot assignment may be equal for all subchannels, or some subchannels may be given higher capacity by assigning them a higher number of timeslots on which to transmit.

Timeslots in TDM systems have various granularities depending upon the application. A timeslot can be as short as a single bit or as long as a full message or packet.

TDM systems employ a timeslot counter (which is often implemented as a counter at each transmitter and receiver, synchronized by a system-wide clock and Sync signal). This counter counts from 0 to a maximum value corresponding to the number of timeslots in the system, and recycles back to 0. Transmitters and receivers employ a timeslot map storage array, often implemented with RAMs, to hold the database that maps timeslots to transmitters or receivers. System wide control functions coordinate the contents of these map RAM's among all the transmitters and receivers accessing the shared medium to insure each timeslot is assigned to at most one transmitter. If more than one transmitter map RAM holds an enable value for the same timeslot, a collision occurs, and the shared channel's data will be corrupted. If no transmitter is using a timeslot, it is considered idle, and is available for assignment to a transmitter with traffic (or additional traffic) to send.

The rate that a timeslot counter counts through all its values and recycles is referred to as the “frame rate”. Many interesting tradeoffs occur when choosing this value for a system. Choosing too fast a frame rate causes problems such as encountering the physical limits of the channel's information bandwidth, having too few channels available, and reducing the system's efficiency because each transmitter cannot access the channel long enough to send a message of meaningful length. Conversely, if the frame rate chosen is too slow, latency becomes an issue. Channels are not served fast enough, leading to perceivable delays to users of the system, and in extreme cases, transmit buffer overflows. Systems that are optimized to carry voice typically use frame rates of 8 KHz, with several thousand timeslots.

TDM systems of useful physical sizes running at electronic or optical data rates need to take into account the time it takes for a timeslot's information to pass over the physical medium between the transmitter and receiver. It is important that the synchronization and MAC algorithms take into account the non-zero propagation time of the messages. Often, a technique called “guard bands” is employed to insure that a transmitter on one extreme physical end of the medium is disabled, and its transmission has adequate time to propagate to the opposite extreme end of the medium before any other transmitter is permitted to engage. Guard bands reduce the utilization efficiency of a system, and careful system timing design and physical layout can reduce their efficiency penalty.

TDM is a useful multiplexing and MAC protocol in systems that use a free space optical beam line as the shared access media to interconnect processing units in a stored program controlled system. Therefore, there is a need in the art to provide a free space optical interconnect between units of a stored program controlled system using a time division multiplex system.

### SUMMARY OF THE INVENTION

This need is satisfied and a technical advance is achieved in the art by a system and method that provides time division multiplexing in a system that uses free space optics to interconnect processing units of a stored program controlled system. The system of this invention uses Time Division Multiplexing techniques to provide a plurality of logically independent subchannels over a single shared free space optical beam line. The single logical beam is divided temporally among the subchannels, with each subchannel operating for a selected timeslot or timeslots.

### BRIEF DESCRIPTION OF THE DRAWINGS

A more complete understanding of this invention may be obtained from a consideration of the specification taken in conjunction with the drawings, in which:

FIG. 1 is a perspective view of a beam line illustrating the relationship of the beam line and probes according to a general overview of an exemplary embodiment of this invention;

FIG. 2 is a cross-sectional view of the beam line of the exemplary embodiment of FIG. 1;

FIG. 3 is an exemplary embodiment of transmitting and receiving probes of FIGS. 1 and 2;

FIG. 4 is a block diagram of an exemplary embodiment of this invention wherein each of the processing units communicate with each other;

FIG. 5 is a block diagram of a signal generator of FIG. 4;

FIG. 6 is a block diagram of a transmit and receive protocol handler according to an exemplary embodiment of this invention;

FIG. 7 is a timing diagram of a time division multiplex system according to an exemplary embodiment of this invention; and

FIG. 8 is a flowchart of operation of bandwidth management for increasing or decreasing the capacity of each subchannel.

### DETAILED DESCRIPTION

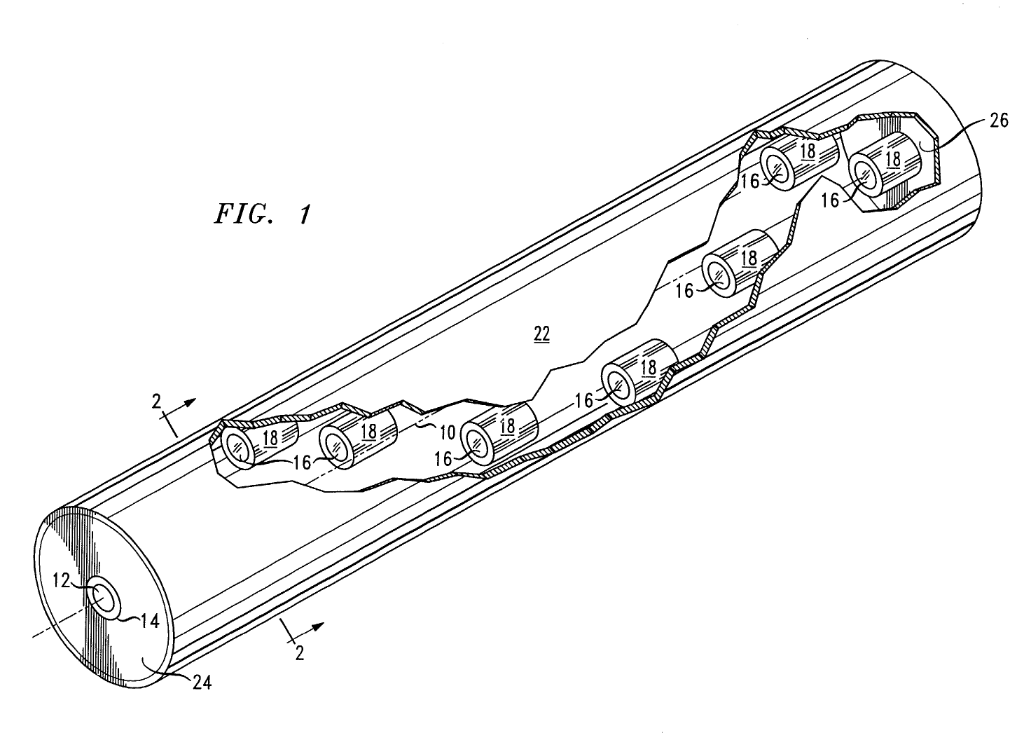

Turning to FIG. 1, a perspective view of a beam line 10 according to one exemplary embodiment of this invention is shown. According to this exemplary embodiment, a beam line 10 is generated by a transmitter 12 within a transmitting probe 14 which projects optically encoded signals, as will be described below in connection with FIG's. 3 and 4. Transmitting probe 14 produces a beam line 10 of desired diameter along the length of its path.

A plurality of receivers 16 within receiving probes 18 are distributed throughout beam line 10 along the outer periphery in the form of a spiral or helix, in this exemplary embodiment. Other possible configurations of probes along the beam line will be apparent to one skilled in the art after studying this disclosure. Receiving probes 18 are distributed in a helix 20 in this exemplary embodiment so that there is a minimal amount of shadowing; that is, one receiving probe 18 being in the shadow of a previous receiving probe 18 in beam line 10 causing the probe in the shadow to receive little or none of the optically encoded signals in beam line 10.

Beam line 10 may be contained within a reserved volume or conduit 22 in an enclosure, such as a cylinder or pipe or, alternatively, may be in the open. If the beam line 10 is contained in a conduit, then the interior surface may be optically absorptive or optically reflective depending upon the length of the pipe, the wavelength of the signal generated by the laser within transmitter 12 and loss budget to provide optimal reception of optically encoded signal by the plurality of receiving probes 18 throughout the length of beam line 10.

Conduit 22 includes, in this exemplary embodiment, a first terminal unit 24 and a second terminal unit 26. First terminal unit 24 includes a transmitting probe 14 and second terminal unit 26 includes a receiving probe 18, in this exemplary embodiment. First terminal unit 24 originates optical beam line 12 and second terminal unit 26 terminates the portion of optical beam line 12 passing beyond the probes 18. As will be discussed further, below, first terminal unit 24 and/or second terminal unit 26 may include both transmitters and receivers, and may be interconnected to recycle the encoded signal.

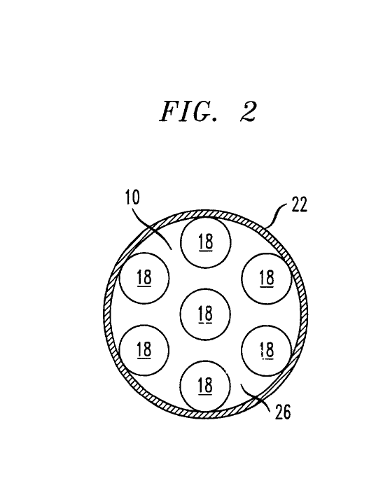

FIG. 2 illustrates a view looking down a cross-section of beam line 10 taken along line 2-2 of FIG. 1. Conduit 22 includes a plurality of receiving probes 18 around its inner edge. In the illustration of FIG. 2, the laser of transmitter 12 (FIG. 1) focuses beam line 10 to encompass the interior circumference of conduit 22 whereby each probe 18 receives the encoded optical signal. Second terminal unit 26 is illustrated herein as comprising a receiving probe 18. (Second terminal unit may also include a transmitter 12, not shown.) Alternatively, second terminal unit 26 may comprise an end cap. An end cap may be absorptive in order to stop the beam line 10 or may be reflective (i.e., a mirror or retroreflector) to recycle beam line 10 in the opposite direction.

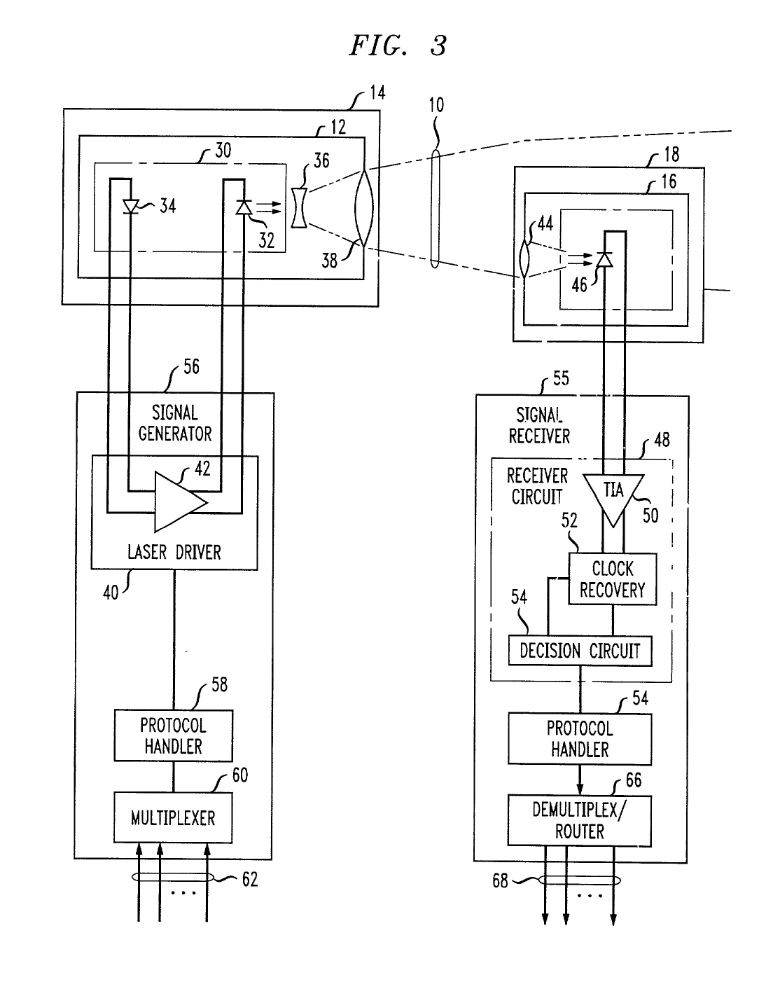

Turning now to FIG. 3, exemplary embodiments of a transmitting probe 14 and a receiving probe 18 are shown. In this exemplary embodiment, transmitting probe 14 includes a transmitter 12 comprising a laser 30 (i.e., a laser diode 32 and a feedback photodetector 34, as known in the art), which converts electronically encoded signals into optical beam line 10. Optical beam line 10 is projected through a concave lense 36 and a convex lense 38 (which form a reverse Galilean telescope, as is known in the art). A laser driver 40 feeds electrically encoded signals to, and receives feedback from, laser 30, as known in the art. Feedback amplifier 42 regulates the input to laser 30. Laser 30 and laser driver 40 are both known to those skilled in the art. Laser 30 and laser driver 40 are illustrated herein as two separate units, but may be one unit.

Beam line 10 is received at a receiving probe 18 at a receiver 16, which includes a convex lense 44 that focuses beam line 10 on a photodetector 46. Photodetector 46 receives a portion of beam line 10 and generates an electrical signal in response thereto. The electrical signal is fed into a receiver circuit 48 comprising a trans-impedance amplifier (TIA) 50, clock recovery circuit 52 and decision circuit 54. embodiment. First terminal unit 24 originates optical beam line 12 and second terminal unit 26 terminates the portion of optical beam line 12 passing beyond the probes 18. As will be discussed further, below, first terminal unit 24 and/or second terminal unit 26 may include both transmitters and receivers, and may be interconnected to recycle the encoded signal.

FIG. 2 illustrates a view looking down a cross-section of beam line 10 taken along line 2-2 of FIG. 1. Conduit 22 includes a plurality of receiving probes 18 around its inner edge. In the illustration of FIG. 2, the laser of transmitter 12 (FIG. 1) focuses beam line 10 to encompass the interior circumference of conduit 22 whereby each probe 18 receives the encoded optical signal. Second terminal unit 26 is illustrated herein as comprising a receiving probe 18. (Second terminal unit may also include a transmitter 12, not shown.) Alternatively, second terminal unit 26 may comprise an end cap. An end cap may be absorptive in order to stop the beam line 10 or may be reflective (i.e., a mirror or retroreflector) to recycle beam line 10 in the opposite direction.

Turning now to FIG. 3, exemplary embodiments of a transmitting probe 14 and a receiving probe 18 are shown. In this exemplary embodiment, transmitting probe 14 includes a transmitter 12 comprising a laser 30 (i.e., a laser diode 32 and a feedback photodetector 34, as known in the art), which converts electronically encoded signals into optical beam line 10. Optical beam line 10 is projected through a concave lense 36 and a convex lense 38 (which form a reverse Galilean telescope, as is known in the art). A laser driver 40 feeds electrically encoded signals to, and receives feedback from, laser 30, as known in the art. Feedback amplifier 42 regulates the input to laser 30. Laser 30 and laser driver 40 are both known to those skilled in the art. Laser 30 and laser driver 40 are illustrated herein as two separate units, but may be one unit.

Beam line 10 is received at a receiving probe 18 at a receiver 16, which includes a convex lense 44 that focuses beam line 10 on a photodetector 46. Photodetector 46 receives a portion of beam line 10 and generates an electrical signal in response thereto. The electrical signal is fed into a receiver circuit 48 comprising a trans-impedance amplifier (TIA) 50, clock recovery circuit 52 and decision circuit 54. In TDM systems, clock recovery function 52 must have special properties. For example, it must maintain lock through guard bands and quickly recover phase alignment as different transmitters activate. Receiver 16 and receiver circuit 48 are well known in the art. Receiver 16 and receiver circuit 48 are illustrated herein as two separate units, with receiver driver 48 contained within a signal receiver 55. However, these two units may be one unit, as is known in the art.

Laser 30 is driven by an electrical signal from signal generator 56. Signal generator 56 comprises laser driver 40, protocol handler 58 and multiplexer 60. Multiplexer receives multiple inputs 62 from one or more processing units, which are multiplexed according to a predetermined algorithm (many algorithms for multiplexing are known in the art and are thus not discussed here). Signals are then passed to protocol handler 58. Protocol handler 58 encapsulates the signals with the protocol used by the optical beam 10, as will be described further below. The signal generated by protocol handler 58 is fed into laser driver 40, which controls laser 30.

On the receiver side, when a signal is received by photo detector 46, it is delivered to signal receiver 55, which comprises receiver circuit 48, protocol handler 64 and demultiplexer/router 66. The received signal is decoded in receiver circuit 48, as known in the art. The receiver circuit 48 is connected to a protocol handler 64 which de-encapsulates the signal received according to the protocol used by protocol handler 58. Protocol handler 64 passes the signal to a demultiplexer and router 66 which demultiplexes the signal and then sends signals 68 to the receiving processing unit or units.

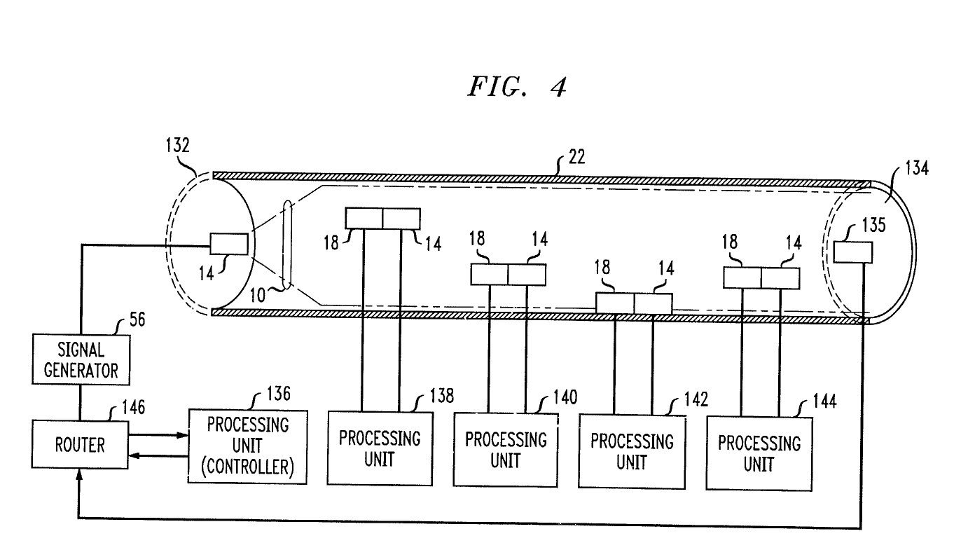

FIG. 4 illustrates an exemplary embodiment of a stored program controlled system that uses an optical beam line to provide communication among processing units wherein a time division multiplex (TDM) protocol according to this invention is used. In this exemplary embodiment, beam line 10 is uni-directional, i.e., signals flow in the direction from uni-directional first terminal unit 132 to second uni-directional terminal unit 134 and are then recirculated, as will be described further below. In this exemplary embodiment, a processing unit controller 136 and processing unit 138, 140, 142 and 144 are each connected to a transmitting probe 14. Processing units 138, 140, 142 and 144, as well as second uni-directional terminal unit 134 are connected to receiving probes 135.

In the exemplary embodiment of FIG. 4, processing unit or controller 136 originates electrical control signals for processing units 138, 140, 142 and 144 and communicates such signals to router 146. Router 146 comprises a conventional router as is known in the art. Router 146 communicates signals for processing units 138, 140, 142 and 144 to a signal generator 56 (as described above in connection with FIG. 3). Transmitter 14 in uni-directional first terminal unit 132 optically encodes the signals, and transmits optical beam line 10. Receiving probes 18 receive the optically encoded signals and convey them to their respective processing unit 138, 140, 142 and 144. Each processing unit 138, 140, 142 and 144 may send feedback or other information to controller 136 by injecting signals into beam line 10, which are all received at terminal receiving probe 135 in uni-directional second terminal unit 134. The signals are then fed back to router 146 where they may be further circulated in beam line 10 or delivered to controller 136.

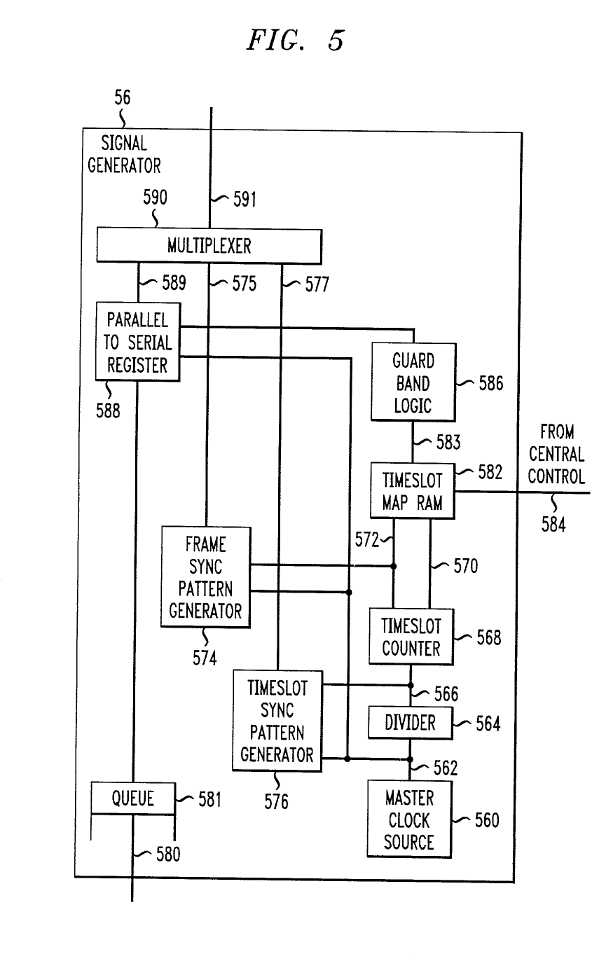

Turning to the block diagram of FIG. 5, details of signal generator 56 (FIG. 4) for multiplexing and media access control capabilities at endpoint 132 are illustrated. Precise timing is especially important to TDM-based systems, therefore signal processing begins with a master clock source 560. Master clock source 560 comprises, in this exemplary embodiment, an accurate crystal oscillator producing a bit-clock signal on line 564.

Bit-clock signal 562 is modified to a lower frequency timeslot clock by divider 562, producing a timeslot clock signal on line 566. The division ratio is determined by the desired number of payload bits per timeslot and the length of the guard bands. Timeslot counter 568 divides the timeslot clock signal 566 by a factor related to a predetermined number, based on the desired number of timeslots in a frame. Timeslot counter 568 then produces a frame sync signal 570, and a timeslot count value 572. Each time the timeslot counter reaches its terminal (maximum) value and recycles, a special frame synchronization pattern 575 is inserted into the signal generator's 56 transmit stream by frame sync pattern generator 574. The timeslot clock signal 566 is processed by the timeslot sync pattern generator 576 to create a timeslot sync pattern 577, which is inserted into signal generator's 56 transmit stream by timeslot sync pattern generator 576.

Timeslot count 572 is applied as an address to one port of a timeslot map RAM 582. Timeslot map RAM (as is known in the art of TDM and thus not further described) typically dual ported, with a second address and data port communicating with a central control processor over control bus 584. The output of the timeslot map RAM 582 is an enable signal 583, which is processed by guard band insertion logic 586 and enables parallel-to-serial register 588. Guard band logic 586 inserts a predetermined amount of time between enable signals, as is known in the art, to allow for signal propagation times.

Parallel data to be transmitted arrives over transmit data input 580, and is held in transmit queue 581 until the enable signal moves (gates) it through the parallel to serial register 588 and out the serial bit stream port 589. When enabled, the parallel to serial register 588 transmits one data bit from the transmit queue 581 per bit clock signal 562 interval. Three serial signals, the frame sync pattern 575, the timeslot sync pattern 577, and the transmit bit stream 589, are combined in multiplexer 590 to produce a composite output signal 591 that is sent to laser driver 40 (FIG. 3). Thus, the clock signals, timeslot sync and frame sync patterns controlling operation of all transmitters and receivers are injected into the beam line 10, according to this exemplary embodiment of this invention. Delivering these control signals in the manner described above obviated the need for electrical (or other fibre optic) signal paths, which would otherwise increase the wiring complexity of this system. However, such external means for communicating control signals comprise another exemplary embodiment that will be understood by one skilled in the art after studying this disclosure.

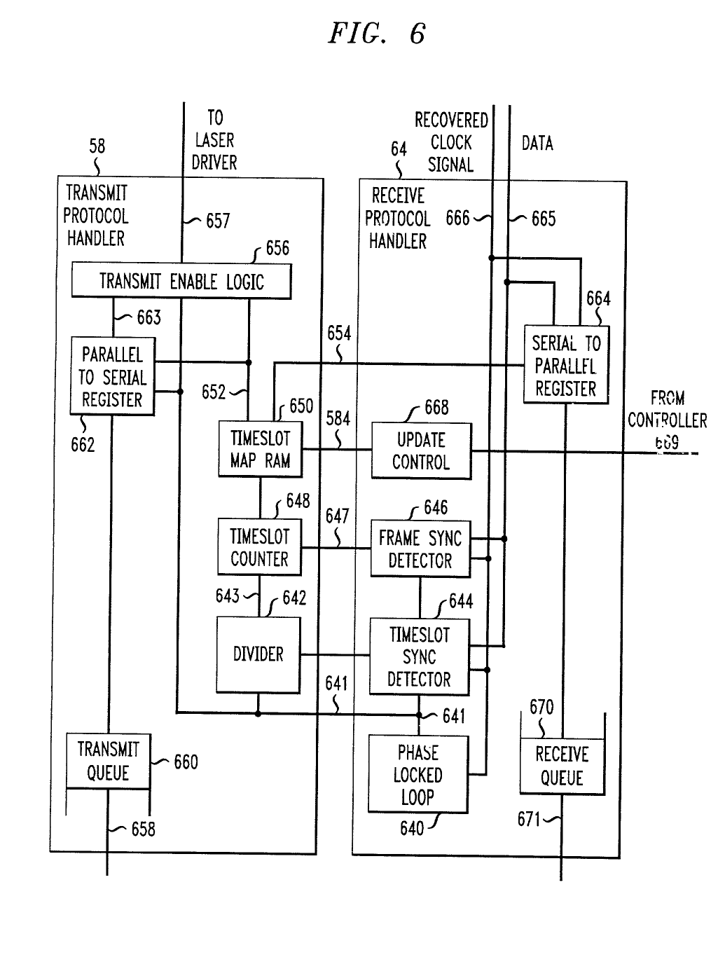

FIG. 6 is a block diagram of the functional components of transmit protocol handler 58 and receiver protocol handler 64 associated with each of the processing units 138, 140, 142 and 144 (FIG.4). A clock signal local to each transmit protocol handler 58 and receiver protocol handler 64 are extracted from the received signals arriving over the beam line through clock recovery logic (not shown, but well known in the art). The recovered clock is delivered over clock line 666 to synchronize a local Phase Locked Loop circuit 640, which generates a local reference clock signal 641. The local reference clock signal 641 is divided by the same factor as master clock source 560 (FIG. 5) in divider 642 to produce local timeslot clock signal 643. Timeslot interval synchronization with signal generator 56 is achieved by a timeslot sync detector 644 responding to the timeslot sync pattern the signal generator 56 periodically sends. A frame sync pattern detects circuit 646 detects the frame synchronization pattern and generates a local frame synchronization pulse 647.

The local timeslot clock signal 643 is used to increment the local timeslot counter 648, and the local frame synchronization pulse 647 periodically resets the local timeslot counter to its base value. Through this mechanism of clock and sync signal distribution from a central source operating many distributed timeslot counters on each of the board level interfaces, system wide distribution of synchronized local copies of the master timeslot counter can be achieved without physical interconnection cables.

The timeslot counter's output is used to provide the address to a timeslot map RAM 650. The contents of map RAM 650 is arranged to provide both a transmitter enable signal 652 and receiver enable signal 654. The transmit enable signal 652 only allows the transmitter's laser to emit energy during the specific timeslot(s) allocated to this particular interface by acting through a transmit enable logic 656. When a transmitter is enabled and transmit data 658 from the processing unit is available for transmission, data is removed from the transmit queue (buffer) 660, sent through a parallel-to-serial register 662 and transmitted to the laser driver 40 (FIG. 3) over link 657. The transmit serial bit stream 663 is synchronized with the local timeslot clock signal 641. If no data is available during an active timeslot (i.e., transmit queue 660 is empty), an idle signal is generated in transmit enable logic 656 and is transmitted in its place.

Receive enable signal 654 regulates the data stream 665 from the receive probe's receiver circuit 48 (FIG. 3) into the receiver serial-to-parallel register 664 only during the specific timeslot(s) allocated to this particular processing unit. Frequently, more receive timeslots will be active than transmit timeslots in order to accommodate broadcast or multicast traffic, which originates at the signal generator 56 (FIG. 3) but may be received on many (or all) of the processing units. The received parallel data is temporarily stored in receive queue 670 until it can be transmitted to the processing unit over receive data link 671. Control message extraction logic 668 detects update control messages, and updates the timeslot map RAM 650 over its second port.

Control of the contents of all the timeslot RAM's associated with a beam line resides with central controller 136 (FIG. 4). Central controller 136 performs system wide bandwidth allocation functions to control which proportion of the total bandwidth available over a beam line will be dedicated to the sub channels of the processing units.

In order to write the contents of the timeslot map RAM 650 on a particular processing unit, central controller 136 produces a special message pattern (similar to the frame synchronization pattern) containing the data to be written and an address and injects it into the signal generator's transmit stream. All of the processing units receive and decode these messages and compare the board address field contained in the address to their geographic address 669 (which is derived from the particular processing unit and slot the interface board is connected to). If the board address field matches the geographic address, the message is addressed to this board and it uses the map address field and data field to write the selected address in the timeslot map RAM 650. The next time the timeslot counter recycles, the new data will cause the updated timeslot assignment to take effect. This above scheme permits reliable and efficient transmission of data between the transmit and receive buffers on the central hub and all the receive and transmit buffers on all the distributed interface boards served by the common beam line.

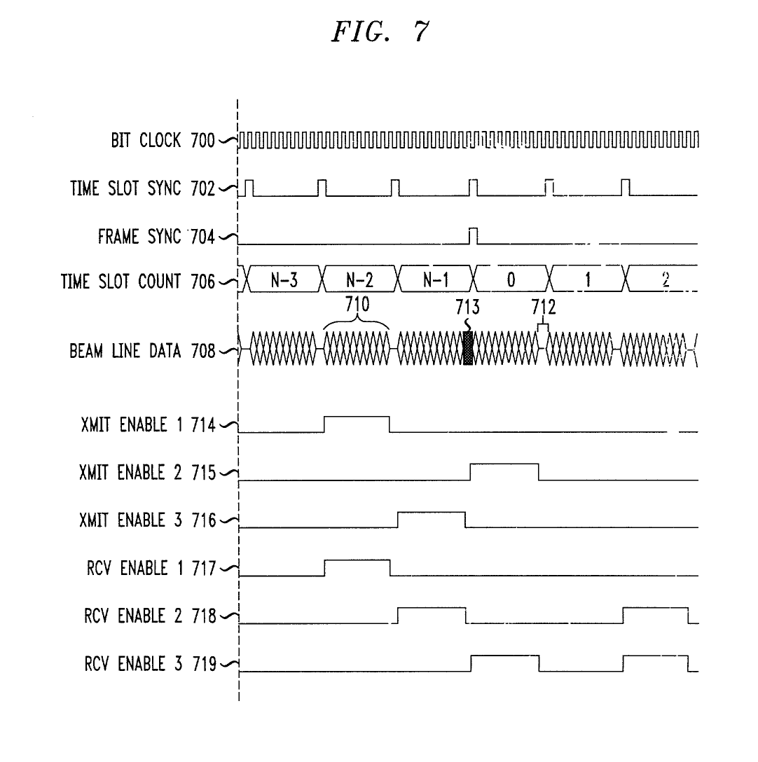

FIG. 7 illustrates a timing diagram for this system according to an exemplary embodiment of this invention. Bit-clock signal 700 governs the high frequency bit rate of the signals in the beam line. Timeslot clock signal, generated by divider 564 (FIG. 5) from bit-clock signal 700, increments timeslot counters system wide. The frame synchronization pulse 704 is the frame sync pattern and is used to reset all the timeslot counters to their base value (zero in this case). The timeslot counter output signal 706 is the address bus of the timeslot map RAM. Optical data on the beam line is shown as signal 708, the active data intervals as signal 710, and the inactive guard bands 712. During the guard bands 712, the timeslot synchronization pattern is transmitted. During inter-frame guard band 713, the frame synchronization pattern is broadcast. Several different enable signals for the various distributed receivers and transmitters are shown as signals 714, 715, 716, 717, 718, and 719. Notice that at most one transmit enable signal is active during a given timeslot. In timeslot 2, multiple receivers are active in this example, denoting a multicast transmission.

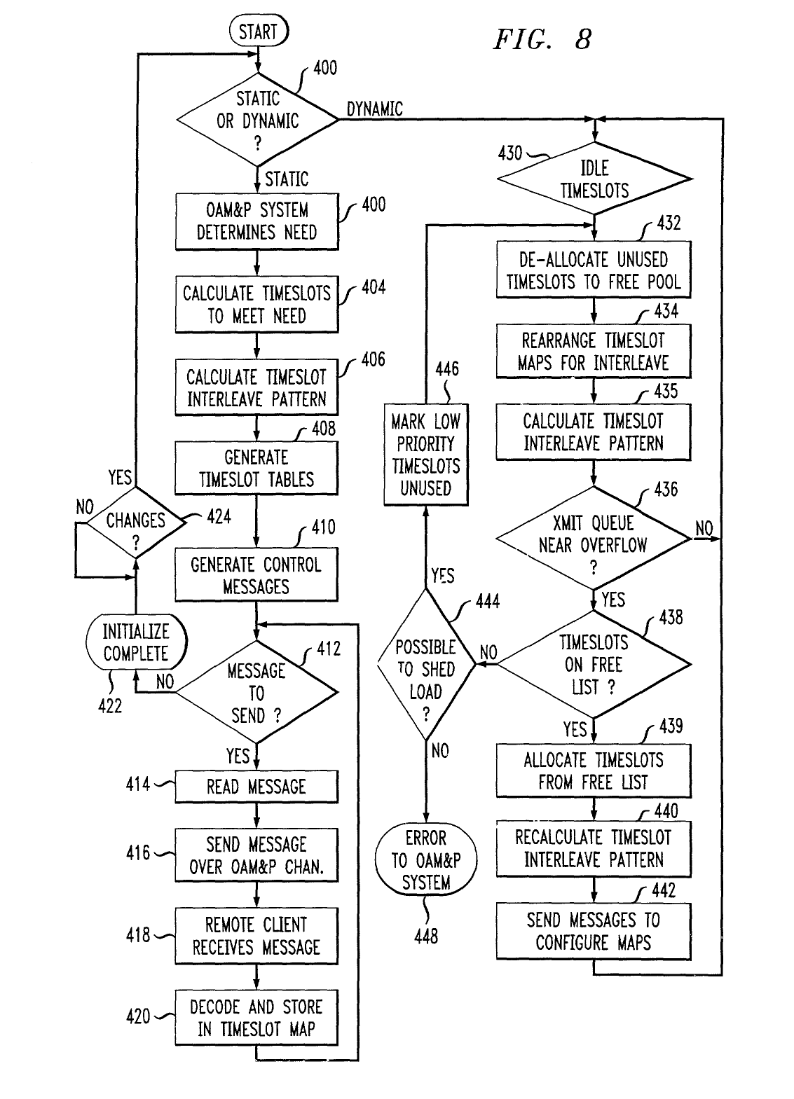

Turning to FIG. 8, a flowchart for the process by which bandwidth is allocated and deallocated in the system is shown. Two paths from decision block 400 exist through this flowchart, depending upon whether a static, fixed multiplexing or dynamic statistical multiplexing strategy is selected.

In Static timeslot mapping, bandwidth in the shared channel is allocated in fixed quanta, equal to the throughput of a single timeslot active in each frame. One or more of these quanta are allocated to a given subchannel, depending upon the bandwidth required. In step 402, an Operations, Administration, Maintenance and Provisioning (OAM&P) system is consulted to determine the bandwidth needs of each sub channel. The number of timeslots per frame required to satisfy the bandwidth need from each processing unit in both directions is calculated in 404. Next, the timeslot interleave pattern is calculated in 406. This pattern is designed to achieve approximately equally temporal spacing between allocated timeslots throughout the frame. Next, in 408, central control creates tables with the timeslot map RAM contents for each processing unit. Control messages are created in step 410. In 412, 414, 416, 418, and 420, a loop is entered in which messages are transmitted over the OAM&P subchannel of the beam line, received at the addressed processing unit and written into the timeslot map RAMs. At this point, the system is initialized 422 and communication in the shared medium commences. The system now enters a loop 424 where it only processes OAM&P orders to change bandwidth.

In Dynamic timeslot mapping, bandwidth between the various endpoints is altered in response to the dynamic demands of the traffic. System initialization is completed as in static mapping using steps 402 through 424 and then the dynamic bandwidth allocation loop is entered. In decision block 430, all receive timeslots are monitored by central control to determine if any currently-assigned timeslot has been idle for more than N timeslots. If so, the idle timeslots are deallocated and returned to a free timeslot pool in 432. In block 434, timeslot rearrangement takes place in order to preserve the timeslot interleave pattern established in 406. Block 435 transmits the messages to the timeslot map RAMs.

In block 436, all the distributed transmit queues are polled to determine if any queue is in danger of overflowing. If so, test 438 is made to determine if any timeslots are available for allocation from the free timeslot list. If a timeslot is available to increase the channel bandwidth to a given processing unit, the new timeslot interleave pattern is calculated in 440. The messages to update the timeslot map RAMs are sent in 442. In case no timeslots are available for allocation, decision 444 determines if there is any low priority traffic that can be temporarily removed from the system to recover some free timeslots. In block 436, the low priority timeslots are identified, and added to the idle list, for processing by steps 432, 434, and 435. If load shedding is not an option, an overload control message is sent to the OAM&P system by 448. The OAM&P system modifies the network parameters at a higher level to reduce the load on this particular node.

It is to be understood that the above-described embodiments are merely illustrative principles of the invention and that many variations may be devised by those skilled in the art without departing from the scope of this invention. It is, therefore, intended that such variations be included within the scope of the following claims.

What is claimed is:

1. A method for use in a stored program controlled system comprising a plurality of processing units and a signal generator for interconnecting processing units using time division multiplexing over a free space optical beam line, said method including the steps of:
generating and distributing a common clock signal to all processing units;
generating, based on said clock signal, and distributing a common synchronization signal to all processing units;
maintaining in each processing unit, at least one timeslot counter synchronized to the clock signal and to the common synchronization signal;
maintaining in each processing unit, a set of timeslot maps synchronized to said at least one timeslot counter;
deriving an enable signal from the contents of the timeslot map to enable transmission of data into the beam line; and
deriving an enable signal from the contents of the timeslot maps to enable one or more receivers to extract data from the beam line.

2. A method in accordance with claim 1 wherein said signal generator includes a timeslot sync signal generator and each processing unit includes a timeslot sync pattern detector, said method further including the steps of:
generating a timeslot sync signal;
sending said timeslot sync signal to each of said processing units;
receiving said timeslot sync signal at each of said sync pattern detectors; and
synchornizing said enable signal in each of said processing units.

3. A method in accordance with claim 1 wherein said signal generator includes a frame sync pattern generator and each processing unit includes a frame sync pattern detector, said method further including the steps of:
generating a frame sync pattern;
sending said frame sync pattern to each of said processing units;
receiving said frame sync pattern at each of said frame sync pattern detectors, and
synchonizing said timeslot counter in each of said processing units.

4. A method in accordance with claim 1 wherein said steps of distributing said common clock signal and said common synchronization signal comprises injecting said signals into said beam line.

5. A method in accordance with claim 1 wherein each processing unit includes a geographic address input, said method further including the step of:
initializing and maintaining said timeslot maps using said geographic address input.

6. A method in accordance with claim 1 wherein each of said processing units includes a transmit queue, said step of enabling transmission of data into the beam line comprising delivering data to the beam line from said transmit queue.

7. A method in accordance with claim 1 wherein each of said processing units includes a receive queue, said step of enabling extraction of data from the beam line comprising receiving data from the beam line in said receive queue.

8. A method in accordance with claim 1 wherein said step of enableing one or more receivers comprising enabling a plurality of receivers to simultaneous receive signals creating multicast channels.

9. A method in accordance with claim 1 wherein said signal generator includes guard band logic, said method further including the step of:
periodically inserting guard bands into said beam line.

10. A method in accordance with claim 1 further including the step of:
updating said timeslot mapping to provide dynamic load balancing.

11. A method in accordance with claim 1 wherein said time slot mapping comprises distributing timeslots assigned to a given channel evenly throughout said timeslots to minimize latency, said step of deriving an enable signal occuring serially across all of said processing units.

12. An apparatus for use in a stored program controlled system comprising a plurality of processing units for interconnecting processing units using time division multiplexing over a free space optical beam line, said apparatus comprising:
a signal generator including
a clock configured to generate and distribute a common clock signal to all processing units;
a synchronization signal generator receiving said clock signal, and configured to distribute a common synchronization signal to all processing units;
each processing unit including
at least one timeslot counter synchronized to the clock signal and to the common synchronization signal;
a set of timeslot maps synchronized to said at least one timeslot counter;
means for deriving an enable signal from the contents of the timeslot map to enable transmission of data into the beam line; and
means for deriving an enable signal from the contents of the timeslot maps to enable one or more receivers to extract data from the beam line.

13. An apparatus in accordance with claim 12 wherein said signal generator includes a timeslot sync pattern generator and each processing unit includes a timeslot sync pattern detector.

14. An apparatus in accordance with claim 12 wherein said signal generator includes a frame sync pattern generator and each processing unit includes a frame sync pattern detector.

15. An apparatus in accordance with claim 12 wherein each processing unit includes a geographic address input configured to initialize and maintain said timeslot maps.

16. An apparatus in accordance with claim 12 wherein each of said processing units includes a transmit queue configured to receive data from said processing unit and deliver data to the beam line.

17. An apparatus in accordance with claim 12 wherein each of said processing units includes a receive queue configured to receive data from the beam line.

18. An apparatus in accordance with claim 12 wherein said signal generator includes guard band logic configured to periodically inserting guard bands into said beam line.
